(19) United States
(12) Patent Application Publication
(10) Pub. No.: US 2007/0239551 A1
(43) Pub. Date: Oct. 11, 2007

(54) METHOD AND APPARATUS FOR A PRODUCT ORDERING SYSTEM

(76) Inventor: Michelle G. Zeller, Colfax, NC (US)

Correspondence Address: MOORE & VAN ALLEN PLLC, P.O. BOX 13706, Research Triangle Park, NC, 27709, US

(21) Appl. No.: 11/277,964

(22) Filed: Mar. 30, 2006

(51) Int. Cl. G06Q 30/00

(52) U.S. Cl. 705/26

(57) ABSTRACT

A customer is presented with a product ordering interface for a size dependent product such as a window covering. The customer is presented with ordering options. Once the customer has selected the desired product, the user is presented with a measurement confirmation interface. The customer is directed to enter at least one first measurement and one second measurement. The measurement(s) are entered into the customer ordering interface. From these measurements the system calculates a theoretical dimension for a product feature. The customer also measures the actual dimension of the product feature. The ordering system compares the calculated dimension to the customer measured dimension. If the calculated dimension matches the customer measured dimension, the measurement is confirmed.

### BACKGROUND

The invention relates generally to a consumer product ordering system and more particularly to a method and apparatus for providing an ordering system for window coverings or other dimension critical products.

It will be appreciated that many products must be ordered based on customer measured dimensions, including window coverings. Window coverings come in a variety of materials including wood, plastic, fabric, vinyl and aluminum and a variety of styles including horizontal blinds, vertical blinds, woven blinds and shades, pleated blinds and shades, Roman shades, cellular blinds drapery products and the like. Window coverings are sold as stock and custom products. Stock products are manufactured in a variety of standard widths that are intended to fit corresponding standard window sizes. Custom products are manufactured to dimensions specified in a customer's order.

Retail sales methods also vary. These products may be sold on-line, via mail order or at a retail outlet. The customer purchases a specific blind size based on the customer's measurement of the window to be covered. With both stock and custom products, the customer must accurately measure the window to be covered. The customer provides the measurements that are then relied on to purchase the properly sized product.

In any ordering system and for any type of product, when the customer is required to provide measurements for the product, a risk exists that the customer will make a mistake in the measurements. This risk is increased in on-line ordering systems where the customer does not have the benefit of any direct assistance from the retailer or manufacturer when making the measurements. Customer ordering errors may lead to a monetary loss for the customer and/or blind supplier and a loss of good will due to customer dissatisfaction.

Thus, an ordering system for window covering products or other size critical consumer products that provides fail-safe protection against customer measurement errors is desired.

### SUMMARY OF THE INVENTION

The ordering system of the invention has particular utility for on-line product ordering systems although it can be used with other ordering systems such as mail order, telephone orders or the like. In one embodiment of the system of the invention, the customer is presented with a product ordering interface for a size dependent product such as a window covering. The customer is presented with ordering options such as style, color and other options. Once the customer has selected the desired product, the user is presented with a measurement confirmation interface. The measurement confirmation interface presents a pictorial representation of the product related feature to be measured and instructions as to how to properly measure the feature. In the window covering embodiment, the user may be presented with a pictorial representation of a window and instructions as to how to properly measure the window. The customer is directed to enter at least one width measurement and one height measurement of the window to be covered. In an alternate embodiment, the customer may be directed to take multiple height and width measurements of the window. The measurement(s) are entered into the customer ordering interface. From these measurements the system calculates a theoretical dimension for a product feature. For a window covering product, the calculated measurement is the diagonal dimension of the window opening. The customer also measures the actual dimension of the product feature. The calculated dimension is compared to the customer measured dimension. If the calculated dimension matches the customer measured dimension, the measurement is confirmed with the customer and the ordering process continues. If the calculated dimension does not match the customer measured dimension, an error measure is presented to the customer and the customer is directed to remeasure and reenter the dimensions and the confirmation process is repeated. Use of the fail-safe confirmation process of the invention minimizes customer based measurement errors and minimizes losses associated with such errors.

### BRIEF DESCRIPTION OF THE DRAWINGS

FIG. 1 is a perspective view of a window with which the product ordering system of the invention may be used.

FIG. 2 is a block diagram of one embodiment of the apparatus on which the system of the invention may be used.

FIGS. 3, 4, 5 and 6 are screen shots depicting embodiments of the user interfaces of the invention.

FIGS. 7, 8 and 9 are a flow diagrams showing the operation of the system of the invention.

### DETAILED DESCRIPTION OF PREFERRED EMBODIMENTS OF THE INVENTION

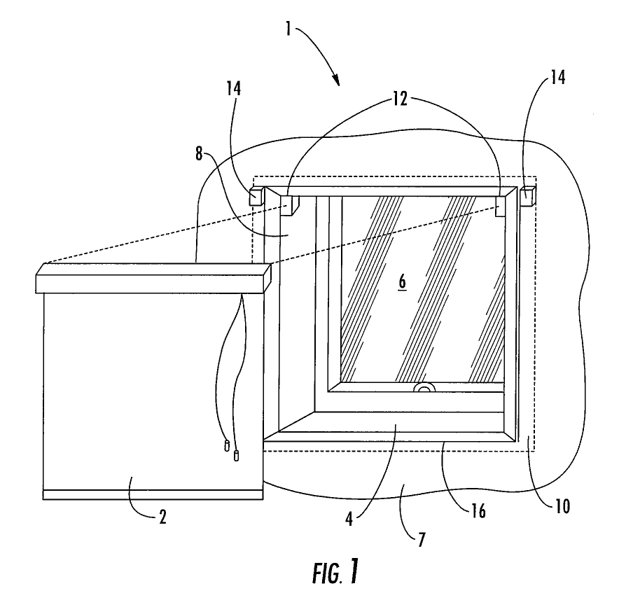

FIG. 1 shows an architectural feature 1 that may be covered by a window covering 2. In the illustrated embodiment the architectural feature is shown as a window, however, the architectural feature may be a door, opening, alcove or other feature. Window covering 2 may be made from any one of a wide variety of materials including, but not limited to, wood, plastic, fabric, vinyl and aluminum. Window covering 2 may also be made in a wide variety of styles including, but not limited to, horizontal blinds, vertical blinds, woven blinds, shades, draperies, pleated blinds, Roman shades and cellular blinds or shades. Moreover, while the system of the invention is specifically described with reference to window coverings, it has use in any customer ordering system where a product is ordered that is sized to match a customer measured feature.

In the illustrated embodiment the window has a frame or casement 4 defining an opening 6 in wall 7 having an inside surface 8 defined by the window frame or casement and an outside area 10 that surrounds the frame or casement. Trim 16 may surround the window as is known. Window coverings may be “inside mount” where the brackets 12 that support the window covering are mounted on the inside surfaces 8 of the window frame or casement 4. Window coverings may also be “outside mount” where the brackets 14 that support the window covering are mounted outside the window frame or casement in area 10. In some applications the mounting brackets 12 and 14 may be the same physical device adapted to be used in either the inside or outside position.

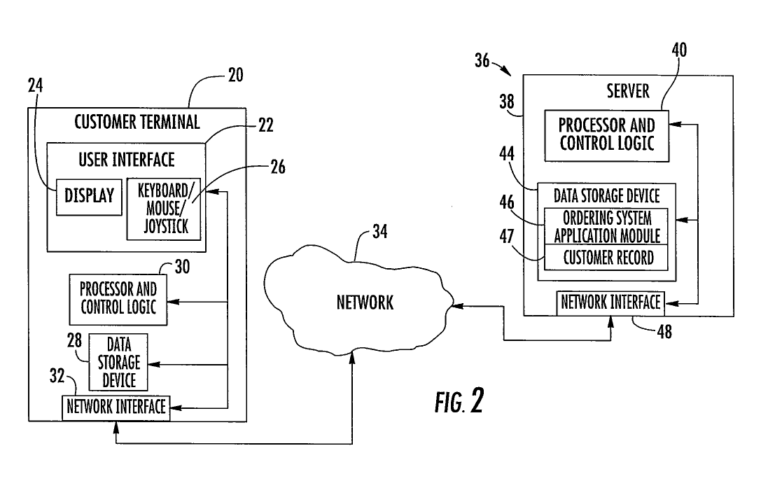

One embodiment of the ordering system of the invention is shown in FIG. 2 and comprises a customer terminal 20 that displays the system interface to the customer. The customer terminal 20 may comprise, for example, a personal computer located at the customer premise. The customer terminal 20 may also comprise a lap top computer or a wireless device such as a personal digital assistant, cellular phone or any other device capable of sending data to and receiving data from the product ordering system 36. The customer terminal 20 may include a user interface 22 to facilitate controlling operation of the customer terminal 20 including establishing a connection to ordering system 36. The user interface 22 may include a display 24 to provide visual images to a customer including the screen shots of the invention described herein. The display 24 may be a liquid crystal display (LCD) or the like capable of presenting color images. The display 24 provides information to a user in the form of images, text, numerals, characters, a graphical user interface (GUI) and the like. The user interface may also include speakers for generating audio. The user interface 22 may also include input devices 26 such as a keypad and function keys or buttons including a point device, such as a mouse or joystick or the like. The input devices 26 permit the user to communicate commands to the customer terminal 20 to establish communications, such as access to the Internet, and send and receive signals. The keypad, function buttons, mouse and joystick 26 may also be used to control the operation of the consumer terminal 20 to enable operation of the ordering system functionality of the invention. A data storage device 28 comprising a computer-readable medium is provided to store computer-executable or computer-usable instructions or data structures to perform operations or functions such as those described in accordance with embodiments of the present invention. The terminal 20 may also include a processor and control logic unit 30. The processor and control logic unit 30 may be a microprocessor or the like. The processor and control logic unit 30 may include and execute application modules, data structures or software programs including computer-executable or computer-readable instructions to control operation of the system of the invention. Appropriate interfaces or ports 32 are provided to connect the customer terminal 20 to the network 34.

The customer terminal 20 is connected to a product supplier's ordering system 36 over network 34. Network 34 may comprise the internet, the public telephone network, a wireless network, a private network such as a LAN or WAN, a cable network or a combination of such networks or similar networks. The supplier's ordering system may comprise a server 38 for executing the method of the invention. The server 38 may include a processor and control logic unit 40. The processor and control logic unit 40 may be a microprocessor or the like. The processor and control logic unit 40 may include application modules, data structures or software programs including computer-executable or computer-readable instructions to control operation of the system of the invention. Server 38 further includes a data storage device 44 comprising a computer-readable medium that is provided to store computer-executable or computer-usable instructions or data structures, such as the ordering system application module 46 of the invention. Appropriate interfaces or ports 48 are provided to connect the customer terminal 20 to the network 34.

Access to the system 36 by the customer terminal 20 may also be made via various intermediate sites. For example, the customer terminal 20 may access a retail outlet's web page that provides a link to the server 38 from which the ordering system of the invention is executed. Likewise, the customer terminal 20 may access a manufacturer's web site that provides a link to server 38 operated by a retail outlet.

It should be noted that computer program code in the form of various computer program instructions can be used to implement at least portions of the processes involved in carrying out embodiments of the invention. Such computer program code can be supplied via a computer program product containing all or a portion of the computer program instructions stored on a media. The media may be fixed, or removable. Such a media is conceptually illustrated at 28 and 46 of FIG. 1 as a fixed storage media, but it could also be a removable optical or magnetic disc or tape. The computer program instructions can reside on any medium that can contain, store, communicate, propagate, or transport computer program code for execution by any type of computing platform, instruction execution system, or collection of such systems interconnected via a bus or network. Such a computer readable medium may be, for example, but not limited to, an electronic, magnetic, optical, electromagnetic, infrared, or semiconductor system, device, or propagation medium. Other examples of the computer-readable medium would include an electrical connection having one or more wires, a portable computer diskette or portable fixed disk, an optical fiber, a compact disc read-only memory (CD-ROM), and a digital versatile disc read-only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Computer program instructions which implement all or a portion of the invention may also be embodied in a stream of information being retrieved over a network such as the Internet. The terms module, application or application module are meant to refer to a specific process that is performed as part of the system discussed throughout and typically comprise software applications.

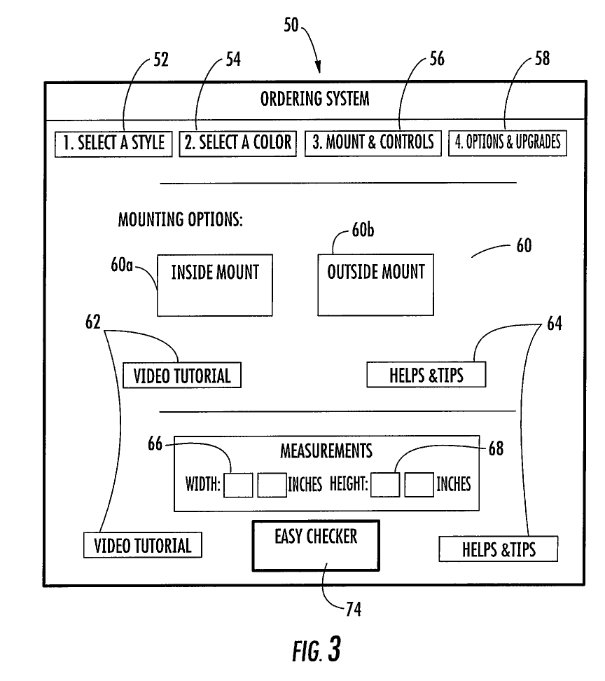

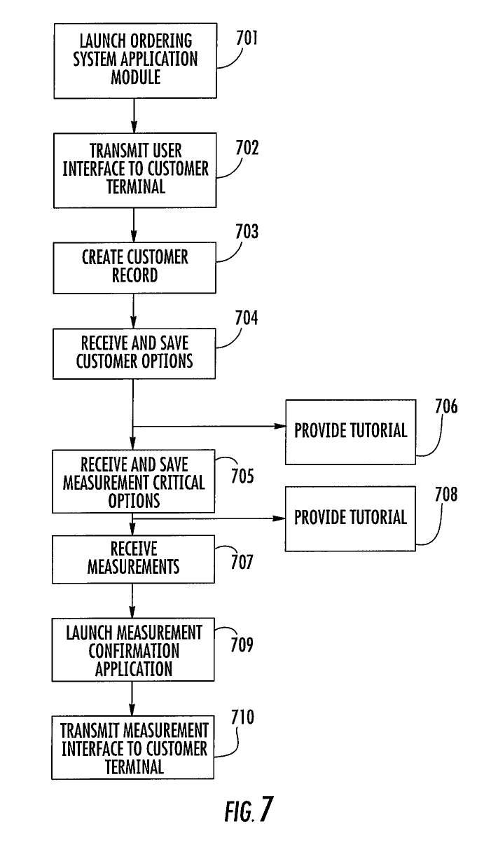

Referring to FIGS. 3 and 7, when the customer accesses the server 38 from which the system of the invention is executed, the ordering system application module 46 is launched (block 701) and a graphic user interface is presented to the customer on the display 24 of the customer terminal 20 (block 702). The initial screens of the graphic user interface may include introductory material to educate the customer as to the function, content and operation of the system and may require a user registration in which customer information such as name, address, e-mail address, customer premise address, payment method may be requested. A customer record 47 is created by server 38 and is saved in data structure 44 for the current customer and session (block 703). The ordering system application module of the invention presents a user interface 50 to the customer, one embodiment of which is shown in FIG. 3. The user interface 50 presents a number of menu options for ordering the product. The customer is first directed to select product specific information. For a window covering the customer selects the style of the covering 52, the color 54, controls 56 and other options/upgrades 58. For other products, the interface may present other options for which customer selections are required. For each option the customer is presented with a number of choices for that option. The choices may be presented in drop down menus or in separate screen shots. The customer selects his or her choices for each option and those choices are transmitted to and received by the server 38 and recorded in the customer record 47 (block 704).

For a window covering, the customer is then directed to select the mounting option 60 for the window covering, either inside mount 60a or outside mount 60b. It will be appreciated that the decision as to whether the mount is inside or outside affects the measurements that are needed to complete the order.

For inside mounts the width of the window opening is measured and for outside mounts the larger measurement of the outside dimension is required. The system of the invention may provide tutorial link 62 and help link 64 that launch applications that provide assistance to the customer in selecting the various options (block 706). Depending on which type of mount the customer selects, the steps for making the measurements will dynamically change to present the correct step-by-step instructions to the customer. Outside mounting is less complex than inside mounting because it doesn't need to take into consideration the imperfections of a window frame as the window covering covers the entire window. Inside mount is more complex and the customer measurements are more critical. It will be appreciated that the measurement confirmation system of the invention may be used with either type of mount if desired.

While the selection of the mounting location is specific for a window covering ordering system, it is to be understood that for other products other decisions may determine the specific measurements required by the system. Such decisions are known as “measurement critical” options and are used by the system to determine which set of measurements are required for the measurement confirmation process. The measurement critical options are transmitted to and received by the server 38 and recorded in the customer record 47 (block 705).

The customer may measure the width and height of the window covering and enter these measurements in windows 66 and 68, respectively, and those choices are transmitted to and received by the server 38 and recorded in the customer record 47 (block 707). Again, tutorial link 62 and help link 64 may be provided that launch applications that provide assistance to the customer in making the measurements (block 708). To confirm the customer measurements the customer may select the “Easy Checker” link 74. The ordering system application module launches the fail-safe measurement confirmation application of the invention (block 709).

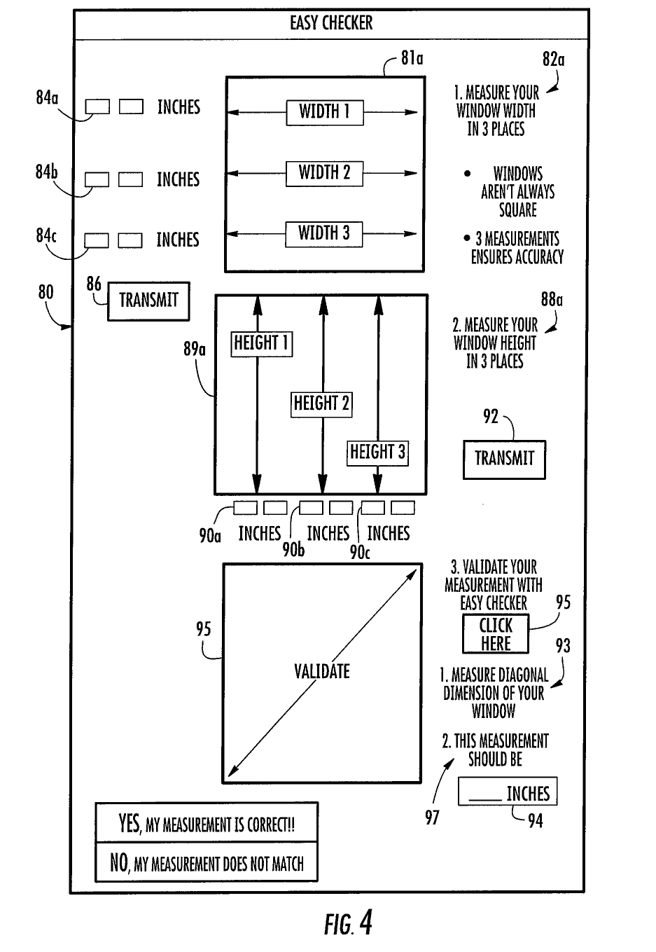

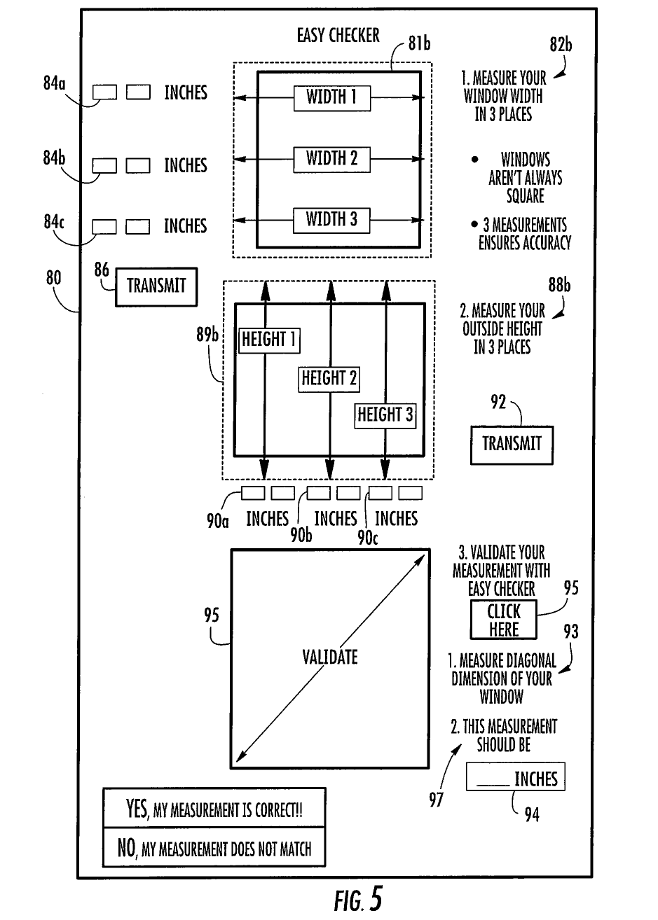

Upon selection of the “Easy Checker” link and based on the measurement critical decisions previously entered by the customer, server 38 transmits and displays to the customer one of multiple measurement interfaces where the interface presented to the customer is determined by the measurement critical options (block 710). In the present embodiment for a window covering, if an inside mount is selected the user interface shown in FIG. 4 is presented. If an outside mount is selected the user interface shown in FIG. 5 is presented. The differences between the interfaces shown in FIGS. 4 and 5 are the images 81a and 81b and the instructions 82a and 82b showing how to measure the width measurements and the instructions 88a and 88b and images 89a and 89b showing how to measure the height measurements.

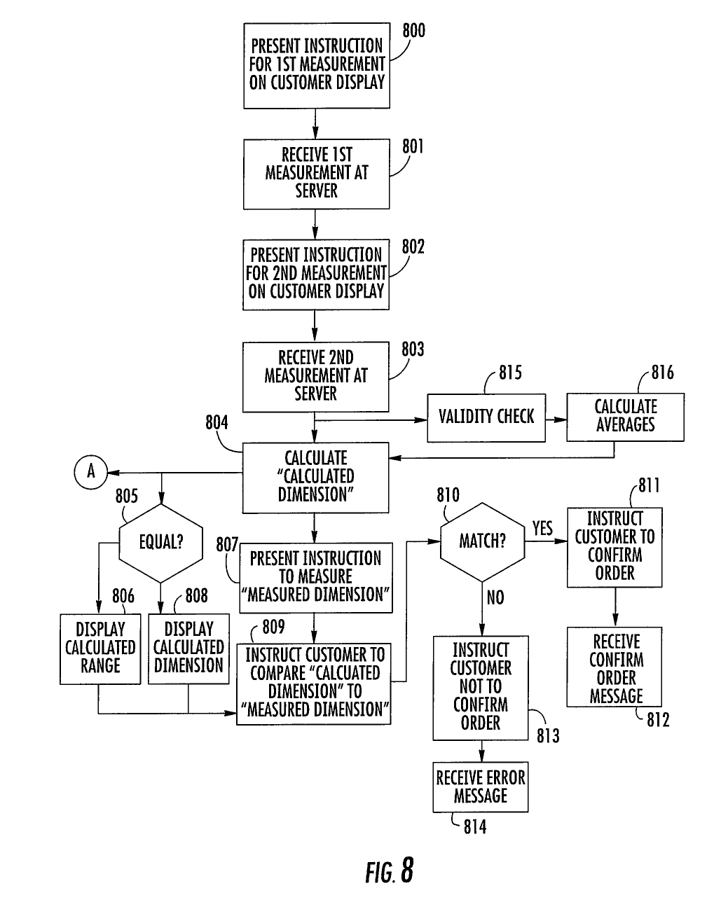

The system of the invention will be described with specific reference to FIGS. 4 and 8, it being understood that the operation of the system shown in FIG. 5 is essentially the same except that the width and height measurements are for an outside mount versus an inside mount. Referring to FIG. 4, an embodiment of the measurement interface for the measurement confirmation process as displayed on display 24 is shown generally at 80. The customer is instructed 82a to measure the width of the opening at three locations, the top, middle and bottom of the opening as shown in image 81a (block 800). While the use of three measurements is desirable to ensure accurate measurement, the system may rely on a fewer or greater number of measurements. The user enters the measurements in the appropriate fields 84a, 84b and 84c and the measurements are transmitted to and received by the server 36 (block 801). The user may be presented with a “transmit” button 86 such that the measurements are transmitted to the server 36 only when the customer initiates the transmission by selecting the transmit function. In the illustrated embodiment the measurements are shown as inches and fractions of inches, it is to be understood that other units may be used.

Once the width measurements are entered, the user is instructed 88a to measure the height of the opening at three locations, the left edge, middle and right edge of the opening as shown in image 89a (block 802). Again while the use of three measurements is desirable to ensure accurate measurement, the system may rely on a fewer or greater number of measurements. The user enters the measurements in the appropriate fields 90a, 90b and 90c and the measurements are transmitted to and received by server 38 (block 803). The user may be presented with a “transmit” button 92 such that the measurements are transmitted only when the customer initiates the transmission by selecting the transmit function.

A “printable form” with instructions may be provided such that the customer is able to print out a copy of the form from the customer terminal and handwrite the measurements on the form as the customer measures the windows at the customer premise. The measurements are then entered into the fields of interface 80 at customer terminal 20.

Based on the entered measurements, the application of the invention calculates the diagonal length (the “calculated dimension”) of the opening based on the height and width measurements entered by the customer (block 804). The system uses the Pythagorean Theorem to calculate the diagonal dimension. It will be appreciated that the Pythagorean Theorem states that for a right triangle, the square root of the sum of the squares of the width (w) and height (h) is equal to the hypotenuse or diagonal (d), or d²=w²+h².

The customer selects a “calculate” or “verify” button 95 and the server calculates the calculated dimension(s) based on the customer entered measurements. The system uses the bottom width entered by the customer and the right-most length entered by the customer and applies the Pythagorean Theorem to obtain a first calculated diagonal dimension. The system uses the top width entered by the customer and the left-most length entered by the customer and applies the Pythagorean Theorem to obtain a second calculated diagonal dimension. The system uses the middle width and middle length entered by the customer and applies the Pythagorean Theorem to obtain a third calculated diagonal dimension. If all of the calculated diagonal measurements are equal (block 805), the system displays one calculated dimension in field 94 (block 808). The dimensions may be considered “equal” if the difference between the values is below a predetermined minimum value where that minimum value is determined such that the difference is insignificant as compared to the accuracy of the over all dimension. The level of accuracy required may differ for different applications. If the calculated diagonal measurements are not equal (block 805), a range of calculated dimensions is created between the smallest calculated diagonal dimension and the largest calculated diagonal dimension and is displayed in field 94 (block 806).

The customer is then instructed to measure the actual diagonal measurement of the window 93 from bottom-left corner to the top-right corner of the window opening d (the “measured dimension”) as shown in image 95 (block 807). The user is instructed 97 to compare the measured dimension of d to the calculated dimension of d (block 809). If the measured dimension of d matches, or is within the range of, the calculated dimension of d (block 810), the user is instructed to select the “YES My Measurement is Accurate” button 96 (block 811) and a message is transmitted to and received by server 38 confirming the order (block 812).

The system may require an exact match between the measured dimension d and the calculated dimension d or a “tolerance” may be provided where if the measured dimension d is within a predetermined range of calculated dimension d the measured dimension is deemed to be a match. The predetermined tolerance range may be an absolute linear distance (e.g. ⅛ of an inch) or a percentage (e.g. 5%). The display of the calculated value d may be presented as “This measurement should be X±Y inches” or “This measurement should be X inches±Z %”. Note the tolerance range could be selected to be zero such that the calculated dimension of d and the measured dimension of d would have to match exactly. If the measurements are not a match (block 810), the user is directed to select the “NO My Measurement is Not Accurate” button 98 (block 813) and a message is transmitted to and received by server 38 indicating that the measurement confirmation failed (block 814). The customer may be instructed to select a “reset” button and re-enter their measurements.

If the measured diagonal is within the range calculated by the system the measurements are determined to be accurate. For an inside mount, the system uses the shortest measured width and the longest measured length as the proper overall dimensions. For an outside mount the system may use the longest measured height and width as the proper dimensions. The customer may bring these measurements to a store or other retail outlet or the customer may enter the measurements into the online ordering system.

If the range of calculated diagonal measurements is too large, for example, the smallest calculated value is more than one-eighth of an inch smaller than the largest calculated value, the system may provide a message that the customer do not use an inside-mount blind on the window because it will not fit correctly or look aesthetically pleasing. The customer can bypass this warning and still receive their measurement by selecting the “show my measurement” button as previously described.

Alternatively, where multiple height and width measurements are received, the system may take an average of the three width measurements and an average of the three height measurements received from the customer (block 816) to determine averages of w and h before calculating the diagonal d. Moreover, the application may include a logic step prior to calculating the value for d to determine if the height and width measurements transmitted by the customer are invalid on their face (block 815). For example, the application may compare the three width measurements and if the measurements differ from one another by more than a predetermined amount (e.g. 10%) an error message will be generated by server 36 and displayed to the user on display 14 indicating that the measurements may be inaccurate and should be remeasured.

It is to be understood that while the disclosed embodiments utilize the Pythagorean Theorem to calculate the calculated dimension and that the calculated dimension is a linear distance, the system of the invention may use other formulas to determine other calculated dimensions. For example, the system could determine volumes, areas, distances other than straight lines, or the like as the calculated dimensions.

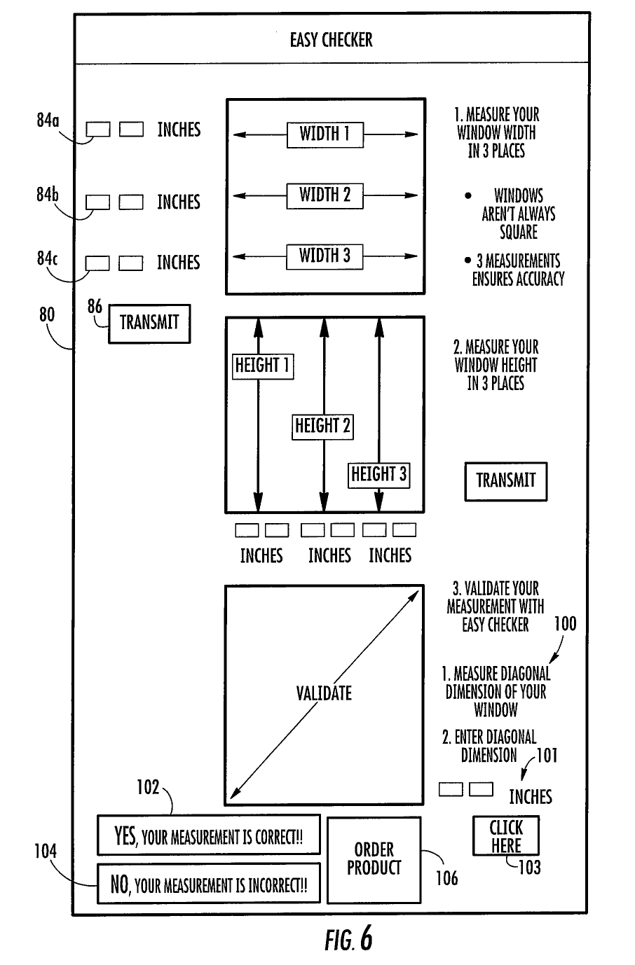

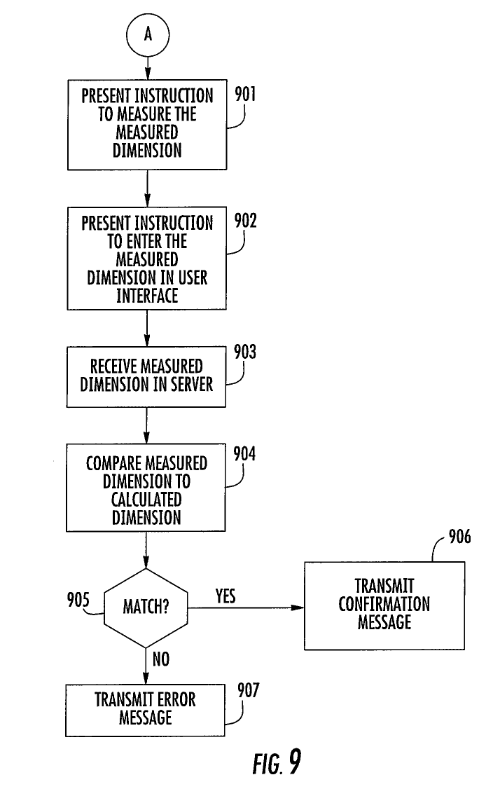

Referring to FIGS. 6 and 9, another alternate embodiment uses the ordering application of the invention to perform all of the comparison steps. In this embodiment the application module of the invention calculates the range of acceptable measurements as discussed above (block 804). The customer is instructed 100 to measure the measured dimension (block 901) and to enter the measured dimension d into field 101 (block 902). A message is transmitted to and received by the server 36 containing the measured dimension d (block 903). A transmit button 103 may be used by the customer to transmit this message. The server compares the received measured dimension d and the calculated dimension d (block 904). The comparison step may include the use of various logic steps previously discussed in determining if there is a match. If the measured dimension matches the calculated dimension (block 905), the server 36 transmits to and displays on terminal 20 a message 102 to the user confirming that the user's measurements are accurate (block 906). If the measured dimension does not match the calculated dimension, the server 36 transmits to and displays on terminal 20 an error message 104 stating that the user's measurements are not accurate (block 907). If the user's measurements are accurate the order may be confirmed such as by the customer selecting an Order Product button 106 that transmits a confirm order message that is received by the server.

The confirmation process may consist of additional interaction between the user and the system such as a generation of price based on the dimensions and the other options selected by the user. The user may also be prompted to confirm the order and the system may transmit a confirmation message with a confirmation number, delivery instructions or the like. The registration steps described previously may also be performed as part of the confirmation process. The system may also provide a “save” option where the user selections are saved but the transaction is not completed. The user may be provided with log-in information to access the saved data at later time.

Where an error is detected, the system may deny confirmation of the order and may direct the customer to retake the measurements. The system may also present a tutorial on the customer terminal showing the customer how to make the measurements. The tutorial may be text or it may be a multimedia presentation.

Specific embodiments of an invention are disclosed herein. One of ordinary skill in the art will recognize that the invention has other applications in other environments. For example, the menu options have been described with specific labels. It will be understood that the menu options may be labeled with other descriptors provided that the functionality corresponds to the functionality as described herein. Many embodiments are possible. The following claims are in no way intended to limit the scope of the invention to the specific embodiments described above.

1. A product ordering method comprising:
receiving a selection of an option for a dimension critical product being ordered;
receiving a measurement of a first dimension;
receiving a measurement of a second dimension;
calculating a theoretical third dimension based on the first dimension and the second dimension;
receiving a measurement of a measured third direction;
comparing said theoretical third dimension to said measured third dimension and confirming the selection based on the results of the comparison.

2. The method according to claim 1 wherein the product comprises a window covering.

3. The method according to claim 1 wherein the first dimension, second dimension and third dimension comprise a feature to be used with said product.

4. The method according to claim 3 wherein the feature comprises a window.

5. The method according to claim 1 wherein the option determines the first dimension.

6. The method according to claim 5 wherein the option comprises an inside mount or outside mount for a window covering.

7. The method according to claim 1 wherein the step of calculating uses the Pythagorean Theorem.

8. The method according to claim 1 wherein the step of receiving a first measurement includes receiving a plurality of first measurements.

9. The method according to claim 1 wherein the step of receiving a second measurement includes receiving a plurality of second measurements.

10. The method according to claim 8 wherein the step of calculating a theoretical third measurement includes calculating an average of said plurality of first measurements.

11. The method according to claim 8 further including validating the first measurements.

12. The method according to claim 1 wherein the step of receiving a selection of an option includes the step of receiving one of a plurality of options, said first measurement being different for different ones of said plurality of options.

13. The method according to claim 1 wherein said product is related to a product feature, said first measurement and said second measurement being of said feature.

14. The method according to claim 13 wherein said product feature comprise an architectural feature.

15. The method according to claim 14 wherein the architectural feature comprises a window.

16. A product ordering method comprising:
receiving a selection of an option for a dimension critical product being ordered from a terminal;
receiving a measurement of a first dimension from the terminal;
receiving a measurement of a second dimension from the terminal;
calculating a theoretical third dimension based on the first dimension and the second dimension;
transmitting the theoretical third dimension to the terminal; and
confirming the selection.

17. A product ordering method comprising:
selecting an option for a dimension critical product being ordered;
measuring a first dimension;
measuring a second dimension;
receiving a calculation of a theoretical third dimension based on the first dimension and the second dimension;
measuring a third direction;
comparing the theoretical third dimension to said third dimension and confirming the selection based on the results of the comparison.

18. An ordering system comprising:
means for receiving a selection of an option for a dimension critical product being ordered;
means for receiving a measurement of a first dimension;
means for receiving a measurement of a second dimension;
means for calculating a theoretical third dimension based on the first dimension and the second dimension;
means for receiving a measurement of a third direction;
means for comparing the theoretical third dimension to said third dimension and confirming the selection based on the results of the comparison.

19. The ordering system of claim 18, wherein the first dimension is the length of a feature.

20. The ordering system of claim 19, wherein the second dimension is the length of a feature.

21. The ordering system of claim 20 wherein the means for calculating uses the Pythagorean Theorem to determine the third dimension.
